(19) United States
(12) Patent Application Publication
(10) Pub. No.: US 2007/0012529 A1
(43) Pub. Date: Jan. 18, 2007

(54) Automatic slack adjuster

(76) Inventors: Kevin L. Kreidler, Brunswick, OH (US); Dean R. Jones, Elyria, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/183,551

(22) Filed: Jul. 18, 2005

(51) Int. Cl. F16D 65/00

(52) U.S. Cl. 188/196 R; 188/73.1

(57) ABSTRACT

An automatic slack adjuster for vehicle brakes to adjust the brake system to compensate for brake wear. The automatic slack adjuster has a body pivotable about an axis for transmitting torque to a brake shaft and at least one component with a toothed portion that includes a ceramic material, such as for example one or both components of a toothed conical clutch.

### BACKGROUND OF INVENTION

Slack adjusters are often used in vehicle brake systems to make adjustments to compensate for brake wear. For example, heavy duty vehicles, such as trucks, often employ brake systems that include an air brake cylinder attached to an automatic slack adjuster. The automatic slack adjuster mounts to one end of a brake shaft such that force applied by the air brake cylinder pivots the slack adjuster and rotates the brake shaft. An S-cam attaches to the other end of the brake shaft and couples to brake shoes such that rotation of the shaft applies the brakes against brake drums. As the brakes wear, however, the clearance between the pads or liners and drums increases and the brake system must be adjusted in order to take up this slack to ensure proper braking.

The automatic slack adjuster serves this purpose by automatically adjusting the brake system to compensate for the slack. Typically, however, components of the slack adjuster can wear over time and adversely affect the slack adjusting function. For example, it is common to employ a one-way conical clutch-type mechanism as part of the automatic slack adjuster. This mechanism typically contains numerous small, fine teeth. When these teeth wear beyond a certain point, the brake adjustment can no longer be made and the slack adjuster has reached the end of its useful life.

### SUMMARY OF INVENTION

The present invention relates to an automatic slack adjuster for vehicle brakes. More specifically, the present invention relates to an automatic slack adjuster for vehicle brakes having at least one component with a toothed portion that includes a ceramic material. It will be appreciated, however, that the invention is also amenable to other applications.

The present invention also relates to a method of adjusting the slack of a vehicle brake system that includes the step of using an automatic slack adjuster that has at least one wear part that includes a ceramic material.

### BRIEF DESCRIPTION OF DRAWINGS

In the accompanying drawings which are incorporated in and constitute a part of the specification, embodiments of the invention are illustrated, which together with a general description of the invention given above, and the detailed description given below, serve to exemplify the embodiments of this invention, wherein:

FIG. 1 illustrates a cross-sectional side view of a first exemplary automatic slack adjuster according to the present invention;

FIG. 2 illustrates a perspective view of the clutch gear of the exemplary automatic slack adjuster of FIG. 1;

FIG. 3 illustrates a perspective view of the wormshaft of the exemplary automatic slack adjuster of FIG. 1.

### DETAILED DESCRIPTION OF DRAWINGS

The present invention relates to an automatic slack adjuster for vehicle brakes. In particular, the present invention relates to an automatic slack adjuster for vehicle brakes having at least one wear part that includes a ceramic material to increase the life of the slack adjuster.

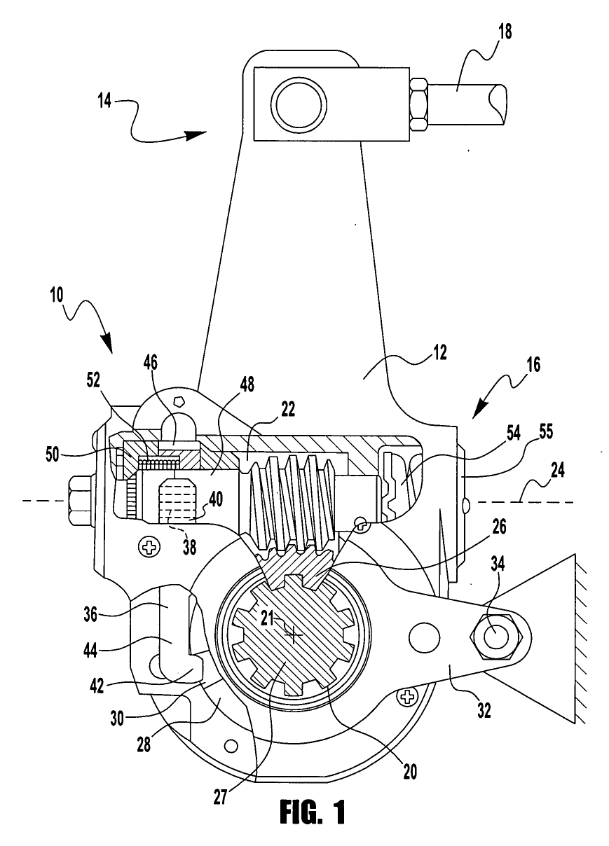

FIG. 1 illustrates the exemplary slack adjuster of the present invention. The general design and operation of the slack adjuster 10 illustrated in FIG. 1 is known in the art and is presented here as an exemplary example. The use of components within the slack adjuster that include ceramic materials, however, is not known in the art. One of ordinary skill in the art will appreciate that the present invention is not limited to the exemplary embodiment of FIG. 1. The use of components that include ceramic materials is applicable to other slack adjuster designs and is included within the scope of this invention.

Since the exemplary automatic slack adjuster 10 of FIG. 1 is well known in the art, only a comparatively brief description will be given. The slack adjuster 10 includes an elongated body 12 having a first end portion 14 and a second end portion 16. The first end portion 12 attaches to a force transmitting device 18, such as for example a push rod for an air brake cylinder. The force transmitting device 18 transmits actuation force through the slack adjuster 10 to apply the vehicle brakes. The second end portion 16 includes a first bore 20 having a first axis 21 and a second bore 22 have a second axis 24, transverse to the first axis. A worm gear 26 rotatably mounts within the first bore 20. The worm gear 26 further mounts onto a rotatable brake shaft 27, such as for example a splined s-camshaft for a drum brake. Thus, the body 12 is pivotably mounted to the brake shaft 27 via the worm gear 26.

A rack follower ring 28 rotatably mounts to the body 12, coaxial to the worm gear 26. The rack follower ring 28 includes a rack engaging portion 30, such as for example a notch, and is rigidly joined to a control arm 32. The control arm 32 mounts to a fixed point 34 such that the body 12 may rotate relative to the rack follower ring 28 in response to force applied by the force transmitting device 18.

A rack 36 having a toothed portion 38 on a first end 40 and a ring engaging portion 42 at a second end 44. The rack 36 is movable along its longitudinal axis, perpendicular to the second axis 24. The toothed portion 38 engages a rack gear 46 that is positioned within the second bore 22 centered on the second axis 24 such that axial movement of the rack 36 rotates the rack gear. The rack gear 46 is positioned onto a worm shaft 48, which is coaxial with the rack gear within the second bore 22. The rack gear 46 can both rotate about the worm shaft 48 and move axially along the worm shaft.

A clutch gear 50 also resides in the second bore 22 coaxial with the worm shaft 48 and rack gear 46. The clutch gear 50 connects to the rack gear 46 by a clutch spring 52. The connection between the clutch gear 50, the clutch spring 52, and the rack gear 46 allows the rack gear to rotate independent of the clutch gear in one direction (during brake application). In the opposite direction (during brake release), however, the rack gear 46 and the clutch gear 50 rotate together. A load spring 54 also resides in the second bore 22. The load spring 54 acts between the body 12 and the wormshaft 48, and may also interact with a spring retainer 55, to bias the wormshaft into engagement with the clutch gear 50.

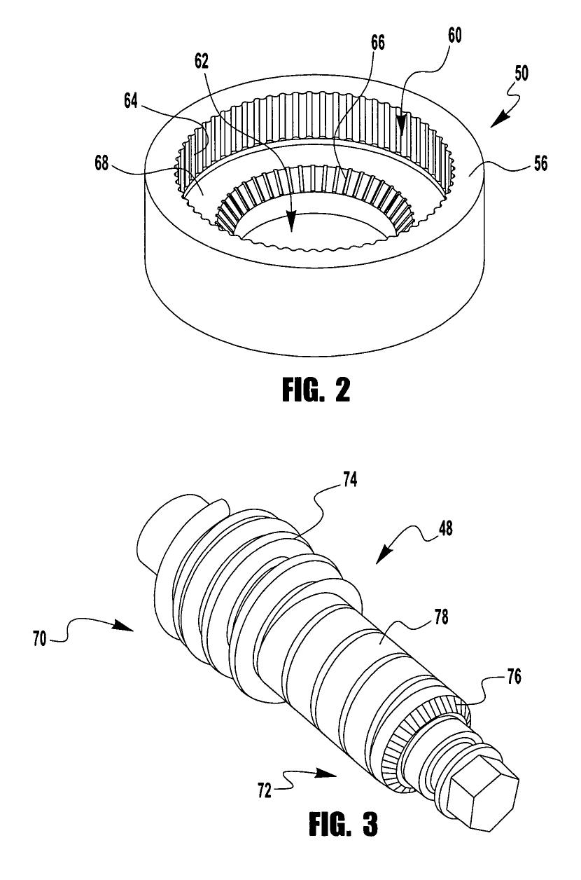

The clutch gear 50 and the worm shaft 48 form a toothed clutch of the exemplary automatic slack adjuster 12. FIG. 2 illustrates the clutch gear 50. The clutch gear 50 has a generally annular configuration which includes a side wall 56, a large opening 60 at one end and a relatively smaller opening 62 at the other end. The sidewall 56 includes a ridged portion 64 adjacent the large opening 60, which is connected to a conical toothed portion 66 by a radially extending surface 68.

FIG. 3 illustrates the worm shaft 48. The worm shaft 48 has a first end portion 70 and a second end portion 72. The first end portion 70 includes a worm element or worm teeth 74 adapted to engage with the worm gear 26. The second end portion 72 includes a toothed portion 76 connected to the worm element 74 by an intermediate portion 78. The toothed portion 76 is adapted to engage the toothed portion 66 of the clutch gear 50. In the exemplary embodiment of FIG. 1, the toothed portions 66, 76 are conical. One of ordinary skill in the art, however, will appreciate that the toothed portions can be configured otherwise, such as saw-toothed, for example. It is through the toothed clutch that the slack adjusting function is performed.

Since the exemplary automatic slack adjuster 10 of FIG. 1 is well known in the art, the detailed operation will be discussed only insofar as it is important for proper understanding of the invention. In operation, the force transmitting member 18 pivots the body 12 counterclockwise (as viewed in FIG. 1) rotating the brake shaft 27 to move the brake pads or linings towards engagement with the brake drums. If the brake pads or linings have worn, then the lower end 42 of the rack 36 will engage the rack follower ring 28 before the brakes contact the drums. The rack follower ring 28 acts as a stop for the rack 36. As a result, as the body 12 continues to pivot, the rack 36 rotates the rack gear 46. When the brakes engage, the amount of torque on the worm gear 26 rapidly increases. The body 12, however, can continue to pivot due to the elasticity of the brakes, components in the system, etc. As the body 12 continues to pivot, the torque on the worm gear 26 causes the load spring 54 to compress and the wormshaft 48 to move axially in the second bore 22 away from the clutch gear 50. As a result, the wormshaft 48 disengages with the clutch gear 50 for the remainder of the brake application.

During release of the brakes, the body 12 pivots in the opposite direction of brake application. As the body 12 pivots back and the brakes begin to disengage, the torque on the worm gear 26 lessens, allowing the load spring 54 to bias the wormshaft 48 back into engagement with the clutch gear 50. As the body 12 continues to pivot back, the rack follower ring 28 causes the rack 36 to move to its lowest position in the body. As a result, the rack 36 rotates the rack gear 46, which rotates the clutch gear 50. Because the clutch gear 50 and wormshaft 48 are engaged, rotation of the clutch gear, rotates the wormshaft, which rotates the worm gear 26 and the brake shaft 27. By rotating the worm gear 26 (and brake shaft 27) relative to the automatic slack adjuster 10, the angular relationship between the brake shaft and automatic slack adjuster is modified; effectively taking up the slack in the brake assembly.

As illustrated above, the automatic slack adjuster 10 includes a number of components that engage to transmit motion between the components. Often these engaging components, such as the worm gear 26, the rack 36, the rack gear 46, the wormshaft 48, and the clutch gear 50, have toothed portions that mesh with each other. This is typical of most automatic slack adjuster designs. These engaging components are susceptible to wear, deformation, etc., which can adversely affect the operation of the slack adjuster. For example, every time the brakes are engaged and released, the toothed portions 66, 76 of the clutch gear 50 and wormshaft 48 engage and disengage. Overtime, the toothed portions 66, 76 wear to the point where the teeth cannot properly engage and slack adjustment can no longer be made. The present invention addresses wear concerns such as this by including a ceramic material in select wear parts of the adjuster 10. For example, in the exemplary embodiment of FIG. 1, at least one of the toothed portions 66, 76 includes a ceramic material. Due in part to the high hardness of these ceramic materials, wear can be reduced between engaging components as compared to prior known designs.

Ceramic material can be introduced to the wear parts, such as for example the toothed portions 66, 76, in a variety of ways. For example, the toothed portion 76 of the worm shaft 48 can be a part of a separate, ceramic piece adapted to slide over the second end 72 of the worm shaft and be secured or attached in position. Attachment of the ceramic toothed portion 76 can be done in a variety of ways, such as for example, a press fit between the ceramic toothed portion and the wormshaft can be provided. Alternatively, a type of mechanical interlock, such as for example threads, a slot-tab arrangement, a tooth-notch arrangement, or some other interlocking arrangement, can be provided. Further, the separate ceramic toothed portion can be bonded to the wormshaft by known methods. In a similar manner, the toothed portion 66 of the clutch gear 50 can be a part of a separate piece that attaches to the clutch gear via bonding, a press fit, mechanical interlock, or other manner.

Ceramic material can be introduced to the wear parts in the automatic slack adjuster 10 by forming the parts from a ceramic material or a material that includes a ceramic material. For example, the entire clutch gear 50 can be formed from a ceramic material. In addition, ceramic material can also be introduced by coating the toothed-portion with a material containing ceramics. Ceramic coatings are widely used in a variety of industries and they can be deposited by a range of deposition technologies including thermal spraying, plasma spraying, vapour deposition (both chemical and physical), sol gel processing or others.

A variety of wear-resistant ceramic materials have been identified as suitable for the present invention. Suitable ceramic materials may include alumina, silicon nitride, chromium nitride, titanium nitride, zirconium nitride, chromium oxide, aluminum oxide, zirconium oxide, titanium chromate, aluminum chromate, silicon carbide, titanium aluminum nitride, titanium carbo nitride, and titanium carbide, although other ceramic materials may be suitable.

While the present invention has been illustrated by the description of embodiments thereof, and while the embodiments have been described in considerate detail, it is not the intention of the applicants to restrict or in any way limit the scope of the appended claims to such detail. Additional advantages and modification will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. An automatic slack adjuster for a vehicle brake system, the automatic slack adjuster comprising:
a body pivotable about an axis for transmitting torque to a brake shaft;
a first component with a first toothed portion; and
a second component with a second toothed portion adapted to engage the first toothed portion,
wherein at least one of the first and second toothed portions includes a ceramic material.

2. The automatic slack adjuster according to claim 1 wherein both the first and second toothed portions include the ceramic material.

3. The automatic slack adjuster according to claim 1 wherein the first component is a wormshaft and the second component is a clutch gear.

4. The automatic slack adjuster according to claim 1 wherein the ceramic material is coated onto the at least one of the first and second toothed portions.

5. The automatic slack adjuster according to claim 1 wherein the first toothed portion includes the ceramic material, the first toothed portion being a part of a separate piece that attaches to the first component.

6. The automatic slack adjuster according to claim 1 wherein the at least one of the first and second toothed portion is conical.

7. An automatic slack adjuster for a vehicle brake system, the automatic slack adjuster comprising:
a body mounted to a brake shaft, the body pivotable about an axis for transmitting torque to the brake shaft; and
a toothed clutch formed between a first toothed portion of a first component and a second toothed portion of a second component for automatically changing the angular relationship between the body and the brake shaft in response to brake wear;
wherein at least one of the first and second toothed portions includes a ceramic material.

8. The automatic slack adjuster according to claim 7 wherein the first component is a wormshaft and the second component is a clutch gear.

9. The automatic slack adjuster according to claim 7 wherein the at least one of the first and second toothed portions is conical.

10. The automatic slack adjuster according to claim 7 wherein both the first and second toothed portions include the ceramic material.

11. The automatic slack adjuster according to claim 7 wherein the ceramic material is coated onto the at least one of the first and second toothed portions.

12. The automatic slack adjuster according to claim 7 wherein the first toothed portion includes the ceramic material, the first toothed portion being a part of a separate piece which attaches to the first component.

13. A first component of a toothed clutch for an automatic slack adjuster for a vehicle brake system, the toothed clutch rotatably mounted within the automatic slack adjuster for making a slack adjusting movement, the first component of the toothed clutch comprising:
a first toothed portion for engaging a second toothed portion of a second component of a toothed clutch, the first toothed portion including a ceramic material.

14. The first component of the toothed clutch according to claim 13 wherein the first toothed portion is a part of a separate piece which attaches to the first component.

15. The first component of the toothed clutch according to claim 13 wherein the first component is a wormshaft.

16. The first component of the toothed clutch according to claim 13 wherein the first component is a clutch gear.

17. The first component of the toothed clutch according to claim 13 wherein the first toothed portion is conical.

18. The first component of the toothed clutch according to claim 13 wherein the ceramic material is coated onto the first toothed portion.

19. An automatic slack adjuster for a vehicle brake system, the automatic slack adjuster comprising:
a body pivotable about an axis for transmitting torque to a brake shaft;
a first component with a first toothed portion;
a second component with a second toothed portion adapted to engage the first toothed portion; and
a means for resisting wear between the first component and the second component.

20. The automatic slack adjuster according to claim 19 wherein the means for reducing wear includes a ceramic material.

21. The automatic slack adjuster according to claim 20 wherein the ceramic material is coated onto at least one of the first and second toothed portions.

22. The automatic slack adjuster according to claim 19 wherein the first component is a wormshaft and the second component is a clutch gear.

23. The automatic slack adjuster according to claim 19 wherein the first toothed portion is secured onto the first component.

24. A method of adjusting the slack in the brakes of an vehicle brake system, the method comprising the steps of:
providing an automatic slack adjuster having at least one component with a toothed portion that includes a ceramic material;
mounting the automatic slack adjuster to a brake shaft;
applying a force to the automatic slack adjuster to engage the brakes; and
releasing the force on the automatic slack adjuster to disengage the brakes; and
modifying the angular relationship between the automatic slack adjuster on the brake shaft to adjust for slack in the brake system.

25. A method according to claim 24 wherein the step of modifying the angular relationship comprising the steps of:
engaging a toothed clutch; and
rotating the toothed clutch.

26. A method according to claim 24 wherein at least one component is a conical clutch gear.

27. A method according to claim 24 wherein at least one component is a wormshaft.

28. A method according to claim 24 wherein the step of providing an automatic slack adjuster having at least one component with a toothed portion that includes a ceramic material further comprises the step of coating the ceramic material onto the toothed portion.

29. A method according to claim 24 wherein the step of providing an automatic slack adjuster having at least one component with a toothed portion that includes a ceramic material further comprises the step securing the first toothed portion onto the first component.
